(19) United States
(12) Patent Application Publication
(10) Pub. No.: US 2025/0012146 A1
(43) Pub. Date: Jan. 9, 2025

(54) HYBRID MATERIAL ROLLING LADDER WITH LIFT ASSIST LOCKSTEP AND GAS SPRING CASTERS

(71) Applicant: Ballymore Company, Inc., Coatsville, PA (US)

(72) Inventors: William F Frame, Coatsville, PA (US); Christopher M Orlando, Media, PA (US); Ronald E Bernard, Coatsville, PA (US)

(21) Appl. No.: 18/890,111

(22) Filed: Sep. 19, 2024

Related U.S. Application Data
(63) Continuation-in-part of application No. 18/466,740, filed on Sep. 13, 2023.
(60) Provisional application No. 63/583,609, filed on Sep. 19, 2023.
(60) Provisional application No. 63/416,226, filed on Oct. 14, 2022.

(51) Int. Cl. E06C 1/397; B60B 33/00

(52) U.S. Cl. CPC E06C 1/397; B60B 33/0015

(57) ABSTRACT

A bushing guided caster assembly for a hybrid material ladder. The caster assembly has an outer housing in which an inner tubular slide slides within the outer housing on bushings. A caster is attached to the inner slide. A gas spring is formed in the inner tubular slide such that the inner slide slides up within the housing as an increasing force is applied downwardly on the housing until the inner tubular slide has traveled a preselected distance until the fixed ladder feet contact the floor or surface upon which the ladder is supported.

### CROSS REFERENCE TO RELATED APPLICATIONS

This application claims priority to U.S. Provisional Patent Application Ser. No. 63/583,609 filed Sep. 19, 2023 and is also a continuation in part of Ser. No. 18/486,740 filed on Oct. 13, 2023 which claims priority to U.S. Provisional Patent Application Ser. No. 63/416,226 filed Oct. 14, 2022.

### STATEMENT REGARDING FEDERALLY SPONSORED RESEARCH OR DEVELOPMENT

The present invention was not developed with the use of any Federal Funds, but was developed independently by the inventors.

### BACKGROUND

### 1. Field

The Invention relates to a hybrid material rolling ladder with a lift assist lock step and gas spring casters. Existing spring-loaded rolling ladder designs have used coil compression springs and typically sprung rolling ladders are limited to 7 steps in height. The present invention may be used up to 12 steps high. This arrangement with stiction and damping in the gas spring dampers improves the side Pull test performance of the ladder compared to compression springs. Accordingly, there is a need for a new and improved hybrid material rolling ladder with a lift assist lock step and gas spring casters.

### SUMMARY

Disclosed herein is a bushing guided caster assembly for a hybrid material ladder. The caster assembly has an outer housing in which an inner tubular slide slides within the outer housing on bushings. A caster is attached to the inner slide. A gas spring is formed in the inner tubular slide such that the inner slide slides up within the housing as an increasing force is applied downwardly on the housing until the inner tubular slide has traveled a preselected distance until the fixed ladder feet contact the floor or surface upon which the ladder is supported. Also disclosed is a fixed ladder having such as bushing guided caster assembly.

In one preferred form of the invention, the gas spring includes an intermediate tubular member and an elongated inner tubular member which slides within the intermediate tubular member. In another preferred form of the invention, an anti-rotation tab is attached to the outer housing, the anti-rotation tab comprises a slot for receiving a pin which rides therein, rotation of the inner slide is prevented by the pin and slot.

### BRIEF DESCRIPTION OF THE DRAWINGS

The embodiments will be described in detail with reference to the following drawings in which like reference numerals refer to like elements wherein:

FIG. 1 shows a perspective view of a gas spring supported, bushing guided caster and a ladder having same in accordance with the present invention.

FIG. 2 shows a close-up cut-away view of the gas spring and caster of FIG. 1.

FIG. 3 shows a cross-sectional view taken along line 3-3 of FIG. 2.

FIG. 4 shows a cross-sectional view taken along line 4-4 of Figure.

FIG. 5 shows an enlarged cross-sectional view taken along line 5-5 of FIG. 5.

FIG. 6 shows a front perspective view of a second preferred embodiment of a hybrid material rolling ladder with a lift assist lock step and gas spring casters in accordance with the present invention.

FIG. 7 shows a rear perspective view of the hybrid ladder in accordance with the present invention shown in FIG. 6.

FIG. 8 shows a side view of the hybrid ladder in accordance with the present invention shown in FIG. 6.

FIG. 9 shows a rear perspective view of the hybrid ladder in accordance with the present invention shown in FIG. 6.

FIG. 9A shows close-up view of the top step area of the hybrid ladder in accordance with the present invention shown in FIG. 6 taken along box 9A

FIG. 10 shows a close-up of the gas spring caster of the hybrid ladder in accordance with the present invention shown in FIG. 6.

FIG. 11 shows a close-up of the locking step of the hybrid ladder in accordance with the present invention shown in FIG. 6.

FIG. 12 shows a cross-sectional view of the gas spring caster close-up taken along line 12-12 of FIG. 8.

FIG. 13 shows a 12-step ladder in accordance with a third preferred embodiment.

### DETAILED DESCRIPTION

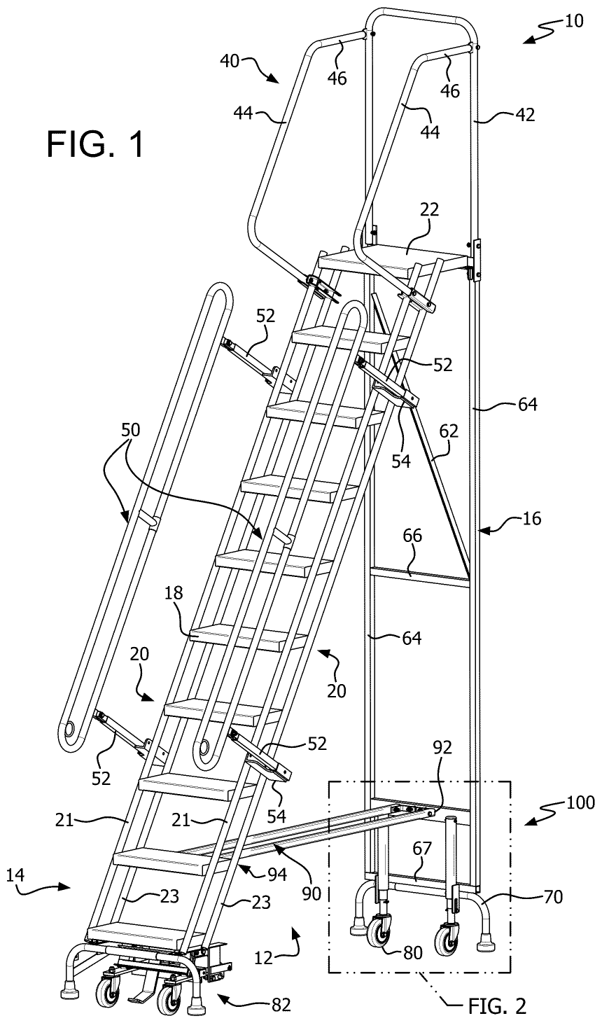

In FIG. 1 there is shown a preferred embodiment of a gas spring supported, bushing guided caster 100 disposed on a rolling ladder 10 in accordance with the present invention. The ladder 10 comprises a base 12 and a stair section 14 attached at its bottom end to the front end of the base. A vertical support 16 connects the top end of the stair section 14 to the back end of the base 12.

The stair section 14 includes a plurality of treads 18 attached to a pair of end rails or stringers 20 forming the stair section and top step or tread 22. Treads are also referred to herein as stairs or steps. The stair section 14 preferably has an elongated parallelogram shape. Preferably, the stair section 14 comprises a substantially one-piece assembly. Preferably, the treads 18 are fixedly attached to the stringers 20 via any suitable means, such as by welding, riveting or the like. The stringers 20 each comprise a top rail 21 and a bottom rail 23.

The top step or tread 22 is attached to the top rail 21 and bottom rail 23 of the end stringers 20. The depth of the top step 22 may be deeper than the remaining steps or treads 18 to facilitate the standing or supporting of an end user or other material to be supported. Typically, the depth of the top step 22 is in the range of about 100% to 300% deeper than the treads 18.

The ladder 10 may also include a top step handrail assembly 40 which encircles the top step 22 on the sides and back. The top step handrail assembly 40 includes a back rail 42 that is typically formed from the top of the vertical support. The top step handrail assembly 40 also includes a front rail 44 that connects to the back rail 42 via a connecting top handrail 46.

A second pair of handrails 50 are connected to the stair section 14 via connecting rails 52 which attach to the top rails 21 and bottom rails 23 of the stringers 20 via brackets 54 and using suitable fasteners, such as bolts and/or locknuts.

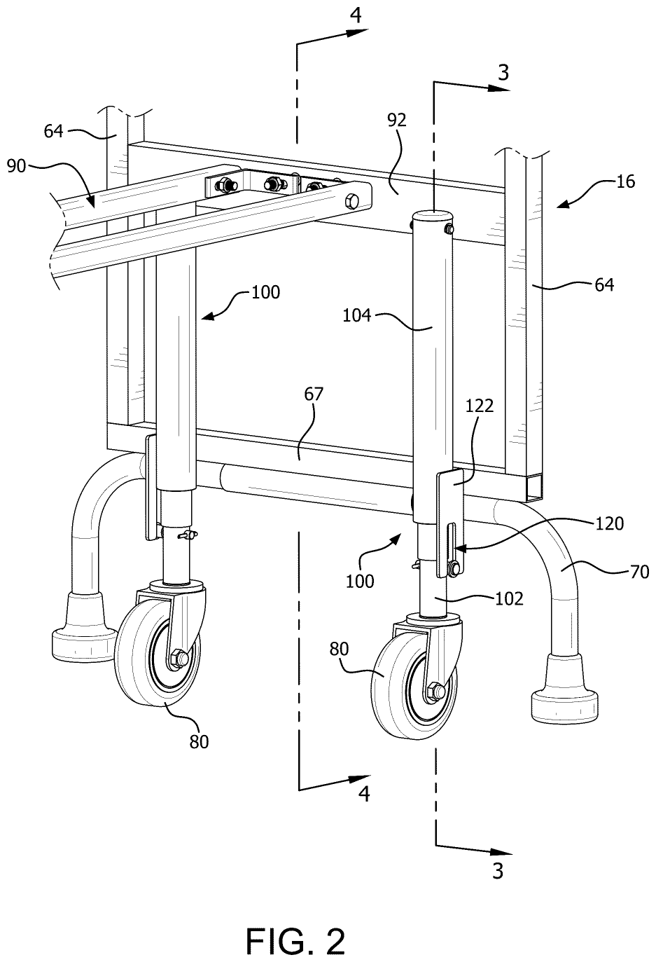

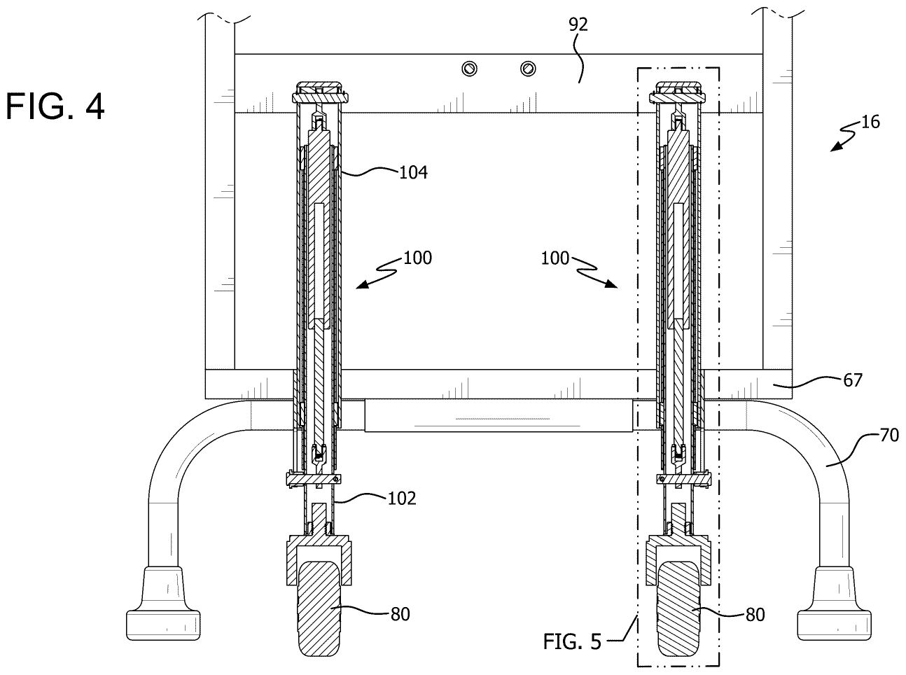

Casters 80 may also be attached to the vertical support 16 to facilitate the mobility of the ladder 10. The term casters as used herein includes casters, wheels, balls or any other rolling device. The casters 80 are attached to the ladder via gas spring supported, bushing guided caster assembly 100, as described in greater detail below in connection with FIGS. 2-5.

The front of the ladder 10 may be provided with a locking step assembly 82 which permits travel of the ladder of the ladder as well as for providing a non-rolling support when desired.

The vertical support 16 comprises a cross brace 62 which connects two upright vertical rails 64, as well as an intermediate horizontal cross rail 66 and a lower cross rail 67 which also connect the vertical rails 64.

A pair of rear feet 70 are attached to the lower cross rail 67.

Horizontal braces 90 are included to further stabilize the ladder. The horizontal braces are attached to the vertical rails 64 via a bracket 92 and at the opposite end 94 to the treads.

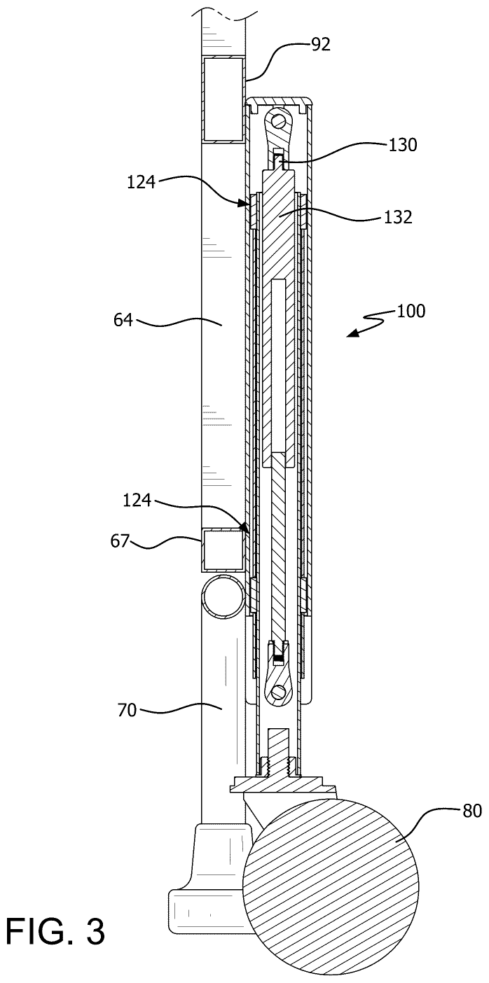

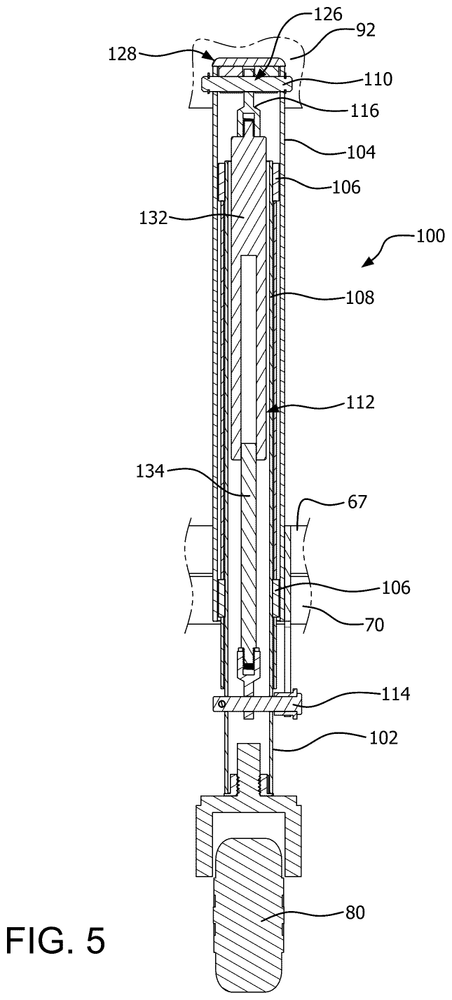

Referring now to FIGS. 2-5, gas spring supported, bushing guided caster assembly 100 includes an outer tubular housing 104 in which an inner tubular slide 102 which slides inside an outer tubular hosing 108, on bushings 106, as best seen in FIG. 5. The outer tubular housing 104 is attached, preferably by welding, fasteners, or the like 124, to the bracket 92 of the rolling ladder 10 as best seen in FIG. 3.

The caster 100 further includes an anti-rotation tab 122 attached to an outward side (relative to a centerline of the ladder 10) of the tubular outer housing 104. The anti-rotation tab 122 has an elongated vertically aligned slot 120 disposed thereon. A pin 114 is received in and slides within the slot 120 as described in greater detail below. The pin 114 extends through a pair of holes formed in the inner tubular slide 102 to constrain its movement as described below. The caster 80 is attached to the inner tubular slide 102 preferably via a threaded connection.

At the top end of the caster 100, a pair of holes are formed therethrough to receive a pin 110 therethrough, as best seen in FIG. 5. The pin 110 is also received through an opening 126 formed in a clevis 116 fixing the clevis 116 to the outer tubular housing 104 at its top end cap 128. A bottom end of the clevis 116 is attached to a tab 130 that extends from the top end of an intermediate tubular member 132.

The intermediate tubular member 132 together with an elongated inner tubular member 134 form a gas spring 112. The weight of ladder 10 is supported by the gas spring 112. The intermediate tubular member 132 attaches at a top end to the outer tubular housing 114 as described above through the tab and clevis connection 116. And, the inner tubular member 134 attaches to the inner tubular slide 102 via pin 114. Additional weight of an operator has sufficient force to collapse the gas spring 112. In this way, the inner tubular slide 102 slides up within the outer tubular housing 104 until the fixed ladder feet 70 contact the floor or surface upon which the ladder is supported. Rotation of the inner tubular slide 104 is prevented by the pin 114 (and bushing 106) riding in the slot 120 of the anti-rotation tab 122.

The total gas spring force should preferably exceed the weight on the rear vertical 16 of the ladder 10 such that the slides 102 and 104 are extended and the rolling ladder 10 can normally roll. As the operator climbs the ladder 10, the portion of their weight applied to the rear vertical 16 of the ladder 10 increases as they climb the stair section. For example, when they reach the third step on a ten-step ladder, approximately ⅓ of their body weight is applied to the rear vertical 16. The gas spring force is selected such that it equals this partial operator body weight plus the static rear vertical weight of the ladder 10. The result is the ladder can normally roll, but the caster slides collapse down and the ladder 10 rests on its feet as the operator reaches the 2nd to 4th step depending on their weight. The transition down is damped by the gas spring assembly 100.

The present invention offers numerous advantages over existing designs such as the slide motion is damped by the gas spring 100, the slide motion is quiet, and the force from the gas spring 100 is relatively constant.

In addition, the ladder 10 is more stable since the user's weight is not in equilibrium with a conventional spring. The users weight typically exceeds the gas spring force and the feet take significant loading. As the user shifts their center of gravity, the gas spring 100 does not push the ladder 100 up off its feet 70 and back into the spring travel range.

The combination of the asymmetric force balance, and friction in the slide operation create some hysteresis in the slide assembly motion. As the operator climbs the rolling ladder 10, it collapses and touches down on its feet, such as on the 3rd or 4th step. When the operator descends the rolling ladder 10, it doesn't pop back up until they reach the 1st or 2nd step.

Moreover, no manual intervention is required to raise this slide to allow rolling ladder 10 after descending. The package can be smaller diameter than a comparable force conventional spring designed for high fatigue life.

In addition, the force of the assembly can be adjusted with the gas spring 100 charge pressure, to suit ladders of different weights. The assembly is easily and safely field serviceable to replace the slide, bushings, and gas spring 100 with simple hand tools. If the ladder 10 is supported on its fixed feet, there is no preloaded force in the assembly.

The setup and operation of the slide requires no mechanical adjustment and can be used in combination with other caster systems-spring loaded, lock step, weight actuated lock step. The internal mounting of gas spring protects it from external damage.

Applications include: rolling ladders, collapsible rolling, portable step stools, collapsible step stools, and mobile work platforms.

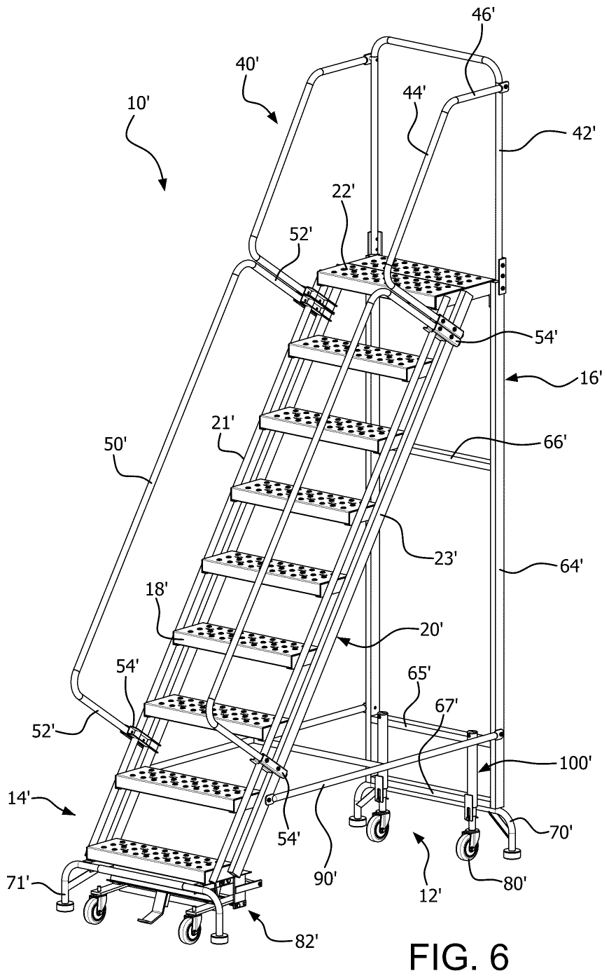

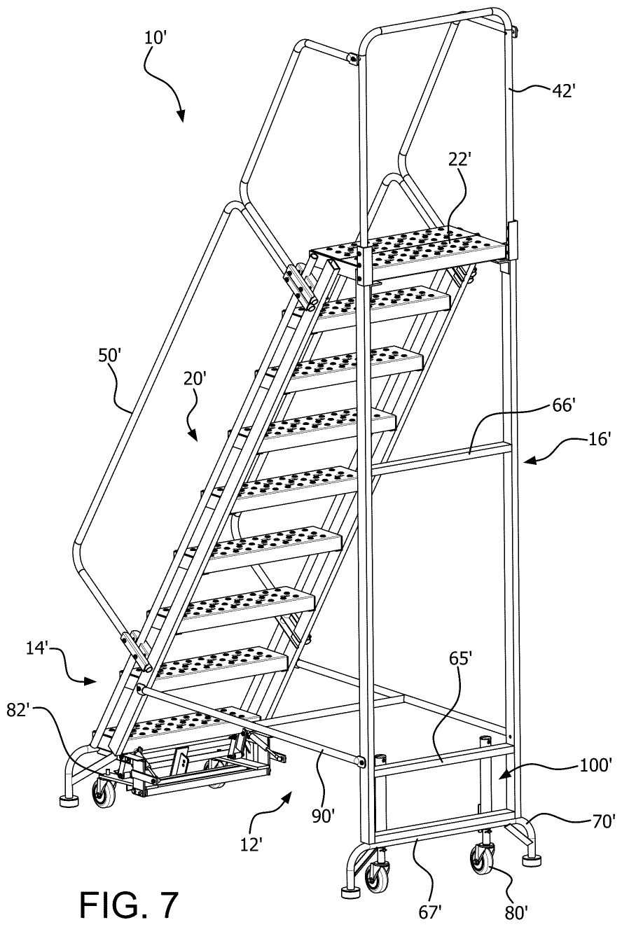

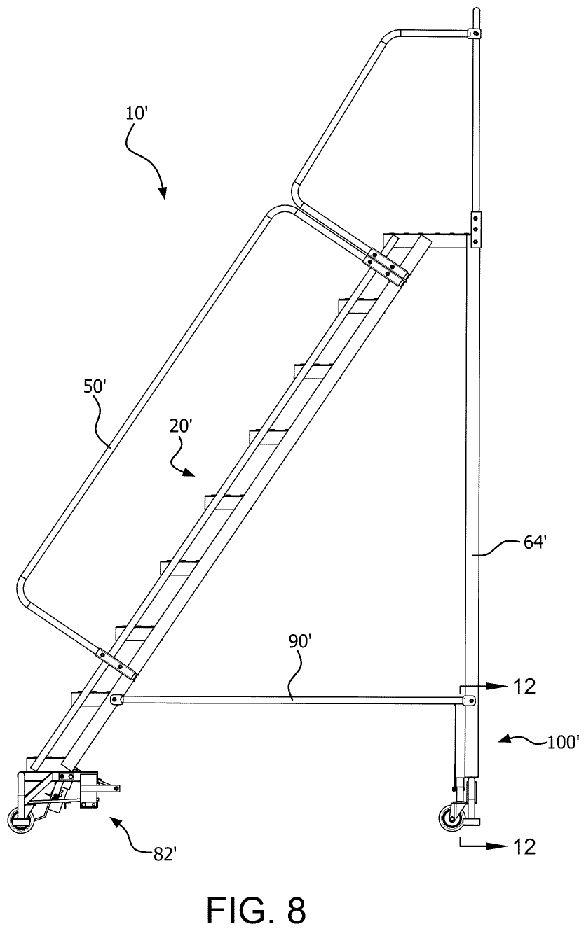

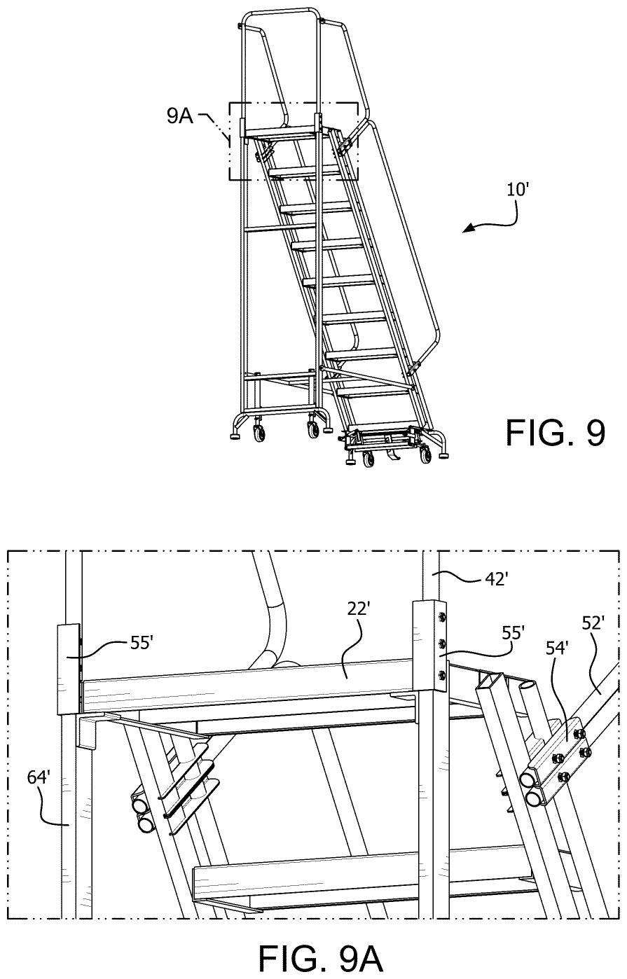

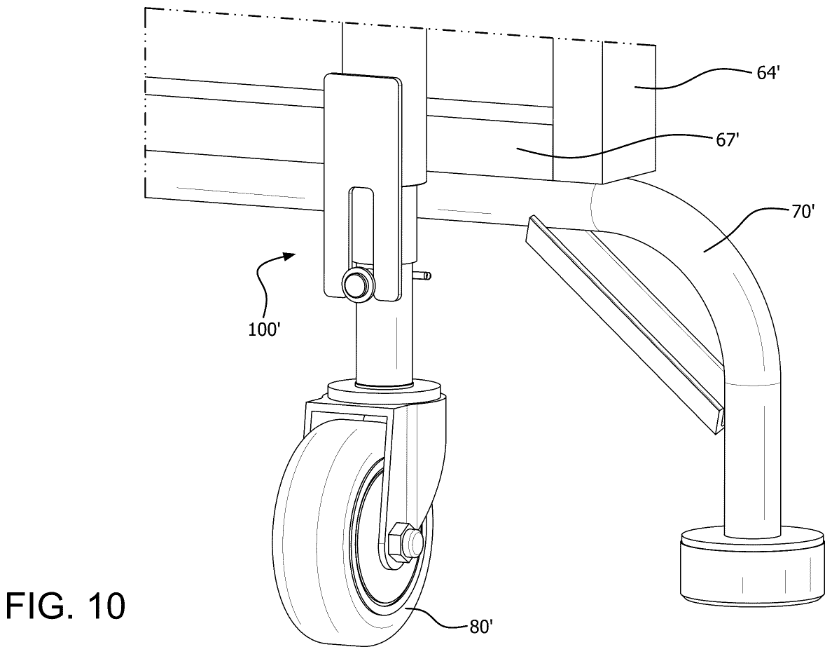

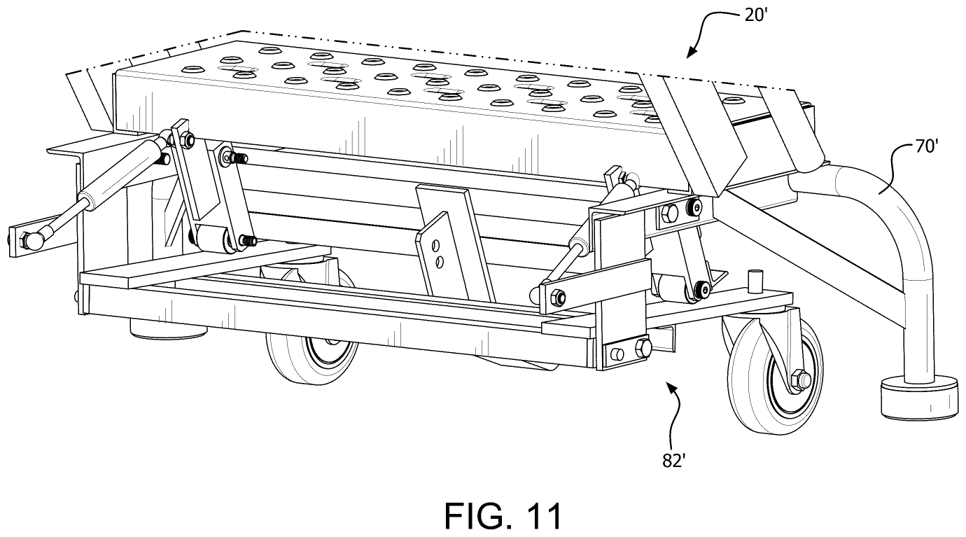

In FIGS. 6-12, there is shown a preferred embodiment of a hybrid material rolling ladder 10′ with a lift assist lock step 82′ and gas spring casters 100′ in accordance with the present invention. Like reference numerals refer to like elements in the embodiment of FIGS. 1-5 with a prime symbol (′) appended thereto.

In FIG. 6-12 there is shown a preferred embodiment of a gas spring supported, bushing guided caster 100′ disposed on a hybrid material rolling ladder 10′ in accordance with the present invention. The ladder 10′ comprises a base 12′ and a stair section 14′ attached at its bottom end to the front end of the base 12′. A vertical support 16′ connects the top end of the stair section 14′ to the back end of the base 12′.

The stair section 14′ includes a plurality of treads 18′ attached to a pair of end rails or stringers 20′ forming the stair section and top step or tread 22′. Treads are also referred to herein as stairs or steps. The stair section 14′ preferably has an elongated parallelogram shape. Preferably, the stair section 14′ comprises a substantially one-piece assembly. Preferably, the treads 18′ are fixedly attached to the stringers 20′ via any suitable means, such as by welding, riveting or the like. The stringers 20′ each comprise a top rail 21′ and a bottom rail 23′.

The top step or tread 22′ is attached to the top rail 21′ and bottom rail 23′ of the end stringers 20′. The depth of the top step 22′ may be deeper than the remaining steps or treads 18′ to facilitate the standing or supporting of an end user or other material to be supported. Typically, the depth of the top step 22′ is in the range of about 100% to 300% deeper than the treads 18′.

The ladder 10′ may also include a top step handrail assembly 40′ which encircles the top step 22′ on the sides and back. The top step handrail assembly 40′ includes a back rail 42′ that is typically formed from the top of the vertical support and connects via a bracket 55′. The top step handrail assembly 40 also includes a front rail 44′ that connects to the back rail 42′ via a connecting top handrail 46′.

A second pair of handrails 50′ are connected to the stair section 14′ via connecting rails 52′ which attach to the top rails 21′ and bottom rails 23′ of the stringers 20′ via brackets 54′ and using suitable fasteners, such as bolts and/or locknuts.

Casters 80′ may also be attached to the vertical support 16′ to facilitate the mobility of the ladder 10′. The term casters as used herein includes casters, wheels, balls or any other rolling device. The casters 80′ are attached to the ladder via gas spring supported, bushing guided caster assembly 100′, as described in greater detail in connection with FIGS. 2-5 and 10.

The front of the ladder 10′ may be provided with a locking step assembly 82′ which permits travel of the ladder of the ladder as well as for providing a non-rolling support when desired.

The vertical support 16′ comprises upright vertical rails 64′. The rails 64′ are fastened to the top step 22′ and rear handrail 42′. Horizontal cross rails, upper cross rail 65′, intermediate cross rail 66′ and lower cross rail 67′ connect the two upright vertical rails 64′ as shown.

A pair of rear feet 70′ and front feet 71′ are attached to the lower cross rail 67′ and to the stringer 20′ respectively.

Horizontal braces 90′ are included to further stabilize the ladder. The horizontal braces 90′ are attached to the vertical rails 64′ and at the opposite end to the bottom rail 23′ of the stringers 20′.

The ladder 10′ is fixedly assembled (preferably by the use of bolt connections with no user adjustment needed for ease of assembly. The rear guardrail 42′ and the rear vertical members 26′ are preferably fabricated from steel.

The lift assist lockstep 82′ bolts to the bottom step and gas spring casters 100′ are welded to the rear vertical 64′ to the cross rails 65′ and 67′. The base member 90′ is bolted between the stair section 20′ and the rear vertical 16′. The hand rails 50′ attach with bolted clamps.

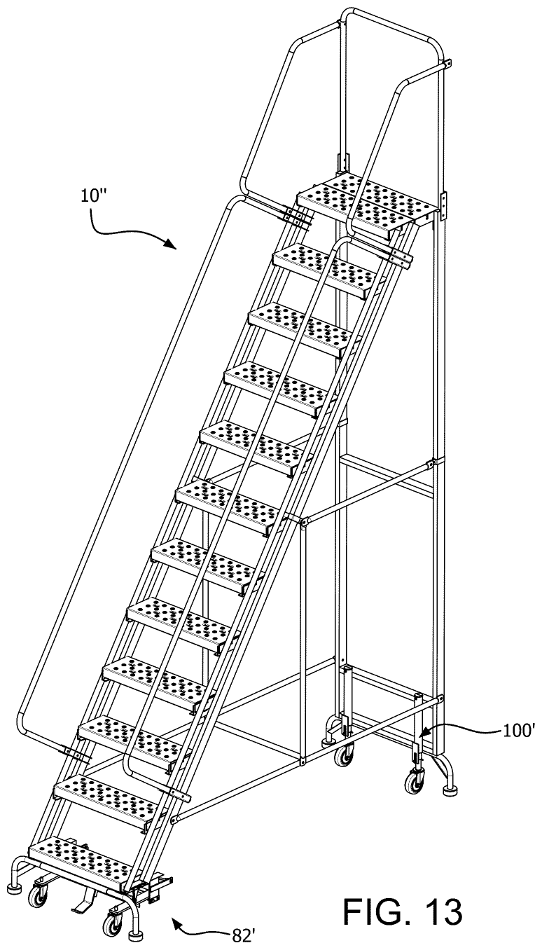

Preferably, the ladder 10′ may be a narrow ladder in 6-8 step range and wide ladders in 6-12 step range. On such preferred 12-step ladder 10″ is shown in FIG. 13.

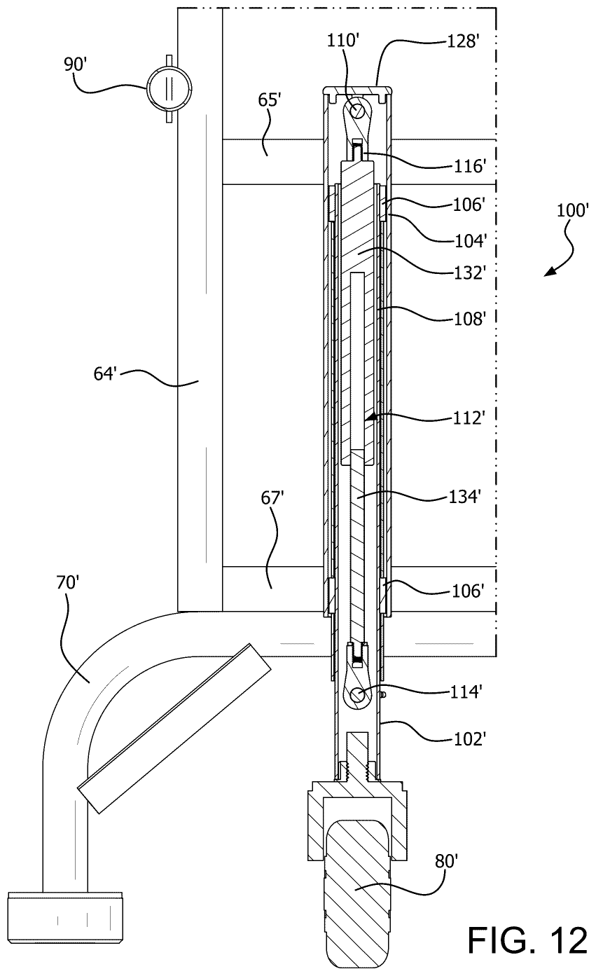

Referring now to FIG. 12, a gas spring supported, bushing guided caster assembly 100′ includes an outer tubular housing 104′ in which an inner tubular slide 102′ which slides inside an outer tubular hosing 108′, on bushings 106′. The outer tubular housing 104′ is attached, preferably by welding, fasteners, or the like to the bracket cross rails 65′ and 67′ of the rolling ladder 10′.

At the top end of the caster 100′, a pair of holes are formed therethrough to receive a pin 110′ therethrough. The pin 110′ is also received through an opening formed in a clevis 116′ fixing the clevis 116′ to the outer tubular housing 104′ at its top end cap 128′. A bottom end of the clevis 116′ is attached to the intermediate tubular member 132′.

The intermediate tubular member 132′ together with an elongated inner tubular member 134′ form a gas spring 112′. The weight of ladder 10 is supported by the gas spring 112. Additional weight of an operator has sufficient force to collapse the gas spring 112′. In this way, the inner tubular slide 102′ slides up within the outer tubular housing 104′ until the fixed ladder feet 70′ contact the floor or surface upon which the ladder is supported.

The combination of lift assist lockstep 82′ and the gas spring casters 100′ provide improved maneuverability and tracking because the casters swivel axis remains plumb. The large wheels and light weight make it very easy to push and turn. The ladder is capable of spinning around in its own length.

The ladder bolts together with minimum fasteners and requires no adjustment to set up. Other approaches with links between their sprung feet can require mechanical adjustment.

The slide motion of the ladder is damped by the gas spring 100′. The force from the gas spring is relatively constant. The ladder is more stable since the users weight is not in equilibrium with a conventional spring. The users weight exceeds the gas spring force and the feet take significant loading. As the user shifts their center of gravity, the gas spring does not push the ladder up off its feet and back into the spring travel range.

The combination of the asymmetric force balance, and friction in the slide operation create some hysteresis in the slide assembly motion. As the operator climbs the rolling ladder, it collapses and touches down on its feet, say on the 3rd or 4th step. When the operator descends the rolling ladder, it doesn't pop back up until they reach the 1st or 2nd step.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A hybrid material rolling ladder comprising:
a lift assist lock step, and
gas spring casters.

2. A bushing guided caster assembly for a hybrid material comprising:
an outer housing.
an inner tubular slide sliding within the outer housing on bushings;
a caster is attached to the inner slide; and
a gas spring formed in the inner tubular slide wherein the inner slide slides up within the housing as an increasing force is applied downwardly on the housing until the inner tubular slide has traveled a preselected distance.

3. The caster assembly according to claim 1 wherein the gas spring comprises an intermediate tubular member and an elongated inner tubular member which slides within the intermediate tubular member.

4. The caster assembly according to claim 1 further comprising an anti-rotation tab is attached to the outer housing, the anti-rotation tab comprises a slot for receiving a pin which rides therein, rotation of the inner slide is prevented by the pin and slot.

5. The caster assembly according to claim 2 further comprising an anti-rotation tab attached to the outer housing, the anti-rotation tab comprises a slot for receiving a pin which rides therein, rotation of the inner slide is prevented by the pin and slot.

6. A hybrid material ladder comprising:
a fixed ladder having fixed feet for contacting a floor or surface;
a bushing guided caster assembly comprising an outer housing; an inner tubular slide sliding within the outer housing on bushings; a caster attached to the inner slide; and a gas spring formed in the inner tubular slide wherein the inner slide slides up within the housing wherein the outer housing is attached to a rear of the ladder wherein when an increasing force is applied downwardly on the ladder by a user on the ladder the inner tubular travels a preselected distance until the fixed ladder feet contact the floor or surface upon which the ladder is supported.

7. The caster assembly according to claim 5 wherein the gas spring comprises an intermediate tubular member and an elongated inner tubular member which slides within the intermediate tubular member.

8. The caster assembly according to claim 5 further comprising an anti-rotation tab is attached to the outer housing, the anti-rotation tab comprises a slot for receiving a pin which rides therein, rotation of the inner slide is prevented by the pin and slot.

9. The caster assembly according to claim 7 further comprising an anti-rotation tab attached to the outer housing, the anti-rotation tab comprises a slot for receiving a pin which rides therein, rotation of the inner slide is prevented by the pin and slot.
